(19) United States
(12) Patent Application Publication
(10) Pub. No.: US 2003/0188034 A1
(43) Pub. Date: Oct. 2, 2003

(54) Method and apparatus for enabling retargetable application architectures

(76) Inventors: Robert N. Goldberg, Emerald Hills, CA (US); Bruce K. Daniels, Capitola, CA (US); Yury Kamen, Foster City, CA (US); Syed M. Ali, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/104,086

(22) Filed: Mar. 22, 2002

(51) Int. Cl. G06F 15/163

(52) U.S. Cl. 709/310

(57) ABSTRACT

A method for generating an enterprise application, including creating a business object specification defining a characteristic of a business object, creating an application usage specification defining how the business object is used in the enterprise application, obtaining a tier specification defining a tiered architecture upon which the enterprise application is executed, and generating the enterprise application based on the business object specification, the application usage specification, and the tier specification.

### BACKGROUND OF INVENTION

Modern enterprise applications are typically implemented as multi-tier systems. Multi-tier systems serve the end-user through a chain of client/server pairs. In general, they include a user interface at the front end, a database management system (DBMS) at the back end, and an application server in between the user interface and the database. Depending on the component providing the user interface, an additional middle tier may exist between the user interface and the application server, For example, if the user interface is provided by a web browser, a web server would exist between the web browser and the application server. The web browser would send requests to the web server, and the web server would interact with application data in the database through the application server in order to generate a response to send to the web browser. In this scenario, the web browser and web server form a client/server pair, the web server and application server form another client/server pair, and the application server and DBMS server form another client/server pair.

FIG. 1 shows an example of a four-tiered system that includes a user interface tier (2), a web server tier (4), an application server tier (6), and a data tier (8). The user interface tier (2) is the layer of interaction and typically includes a form-like graphical user interface (GUI) displayed by a display component, typically a web browser (10). The web server tier (4) includes web components (12) hosted on a web server (14). The web components (12) generate the content displayed by the web browser (10). The application server tier (6) includes application components (16) hosted on an application server (18). The application components (16) model the business rules, typically through interaction with application data. The data tier (8) includes a persistent data store, typically a database management system (DBMS) (22) and a database (20).

The web browser (10) and the web server (14) form a client/server pair. The web server (14) and the application server (18) form another client/server pair. The application server (18) and DBMS (22) form yet another client/server pair. A web component (12) and an application component (16) are in a client/server relationship when the web component (12) (client) uses services of the application component (16) (server) to provide functions to the system. In order for the client and server to collaborate, there must be a contract, or interface definition, between the client and server that specifies the server methods that can be invoked by the client. When the client and server are in different address spaces, the client uses some form of remote procedure call (RPC) to invoke the server methods. Typically, this involves the client calling into a local stub, which forwards the call to the server.

Multi-tiered enterprise applications, such as described above, are difficult to write because they are inherently complex. The application developers are expected to be well-versed in many subject areas. The application developers are expected to be able to understand the business problem and logic to solve the problem, group business logic into transactions, understand how to retrieve and update information in the database, and know how to use multi-processing capabilities to enhance performance of the application. The application developers must also take into account the type of clients to be supported and the communication protocol to be used between the client and server, the type of server and the application programmer interfaces (APIs) supported by the server, and the type of database management system (DBMS) used in managing the database.

### SUMMARY OF INVENTION

In general, in one aspect, the invention relates to a method for generating an enterprise application, comprising creating a business object specification defining a characteristic of a business object, creating an application usage specification defining how the business object is used in the enterprise application, obtaining a tier specification defining a tiered architecture upon which the enterprise application is executed, and generating the enterprise application based on the business object specification, the application usage specification, and the tier specification.

In general, in one aspect, the invention relates to a method for generating an enterprise application, comprising creating a business object specification defining a characteristic of a business object, creating an application usage specification defining how the business object is used in the enterprise application, obtaining a tier specification defining a tiered architecture upon which the enterprise application is executed, generating the enterprise application based on the business object specification, the application usage specification, and the tier specification, specifying a second tiered architecture upon which the enterprise application is executed to produce a second tier specification, re-generating the enterprise application based on the business object specification, the application usage specification, and the second tier specification, generating build/deployment information based on the business object specification and the application usage specification, generating a build/deployment mechanism based on the business object specification and the application usage specification, and generating a deployed enterprise application based on the enterprise application, the build/deployment information, and the build/deployment mechanism.

In general, in one aspect, the invention relates to a computer-readable medium having recorded thereon instructions executable by a processor, the instructions for receiving a business object specification defining a characteristic of a business object, receiving an application usage specification defining how the business object is used in the enterprise application, obtaining a tier specification defining a tiered architecture upon which the enterprise application is executed; and generating the enterprise application based on the business object specification, the application usage specification, and the tier specification.

In general, in one aspect, the invention relates to a computer-readable medium having recorded thereon instructions executable by a processor, the instructions for receiving a business object specification defining a characteristic of a business object, receiving an application usage specification defining how the business object is used in the enterprise application, obtaining a tier specification defining a tiered architecture upon which the enterprise application is executed, generating the enterprise application based on the business object specification, the application usage specification, and the tier specification, specifying a second tiered architecture upon which the enterprise application is executed to produce a second tier specification, re-generating the enterprise application based on the business object specification, the application usage specification, and the second tier specification, generating build/deployment information based on the business object specification and the application usage specification, generating a build/deployment mechanism based on the business object specification and the application usage specification, and generating a deployed enterprise application based on the enterprise application, the build/deployment information, and the build/deployment mechanism.

In general, in one aspect, the invention relates to a computer system to generate an application, comprising a processor, a memory, an input means, a display device, and software instructions stored in the memory for enabling the computer system under control of the processor, to perform receiving a business object specification defining a characteristic of a business object, receiving an application usage specification defining how the business object is used in the enterprise application, obtaining a tier specification defining a tiered architecture upon which the enterprise application is executed, and generating the enterprise application based on the business object specification, the application usage specification, and the tier specification.

In general, in one aspect, the invention relates to an apparatus for generating an enterprise application, comprising means for creating a business object specification defining a characteristic of a business object, means for creating an application usage specification defining how the business object is used in the enterprise application, means for obtaining a tier specification defining a tiered architecture upon which the enterprise application is executed, and means for generating the enterprise application based on the business object specification, the application usage specification, and the tier specification.

In general, in one aspect, the invention relates to an apparatus for generating an enterprise application, comprising means for creating a business object specification defining a characteristic of a business object, means for creating an application usage specification defining how the business object is used in the enterprise application, means for obtaining a tier specification defining a tiered architecture upon which the enterprise application is executed, means for generating the enterprise application based on the business object specification, the application usage specification, and the tier specification, means for specifying a second tiered architecture upon which the enterprise application is executed to produce a second tier specification, means for re-generating the enterprise application based on the business object specification, the application usage specification, and the second tier specification, means for generating build/deployment information based on the business object specification and the application usage specification, means for generating a build/deployment mechanism based on the business object specification and the application usage specification, and means for generating a deployed enterprise application based on the enterprise application, the build/deployment information, and the build/deployment mechanism.

Other aspects and advantages of the invention will be apparent from the following description and the appended claims.

### BRIEF DESCRIPTION OF DRAWINGS

FIG. 1 illustrates a typical multi-tier system.

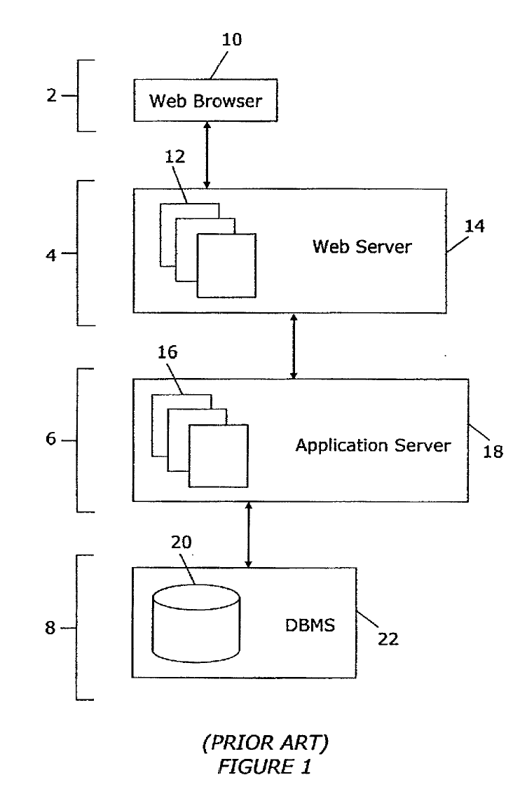

FIG. 2 illustrates a typical computer.

FIG. 3 illustrates a flow diagram for generation of an enterprise application in accordance with one or more embodiments of the invention.

FIG. 4 illustrates a graphical representation of a business object specification in accordance with one or more embodiments of the invention.

FIG. 5 illustrates a graphical representation of an application usage specification in accordance with one or more embodiments of the invention.

FIG. 6 illustrates a tier specification in accordance with one or more embodiments of the invention.

### DETAILED DESCRIPTION

Exemplary embodiments of the invention will be described with reference to the accompanying drawings. Like items in the drawings are denoted by the same reference numbers throughout for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for developing and generating an enterprise application. Further, the invention relates to using a business object specification and an application usage specification to develop and generate the enterprise application. Further, the invention relates to re-generating an enterprise application for a plurality of platforms.

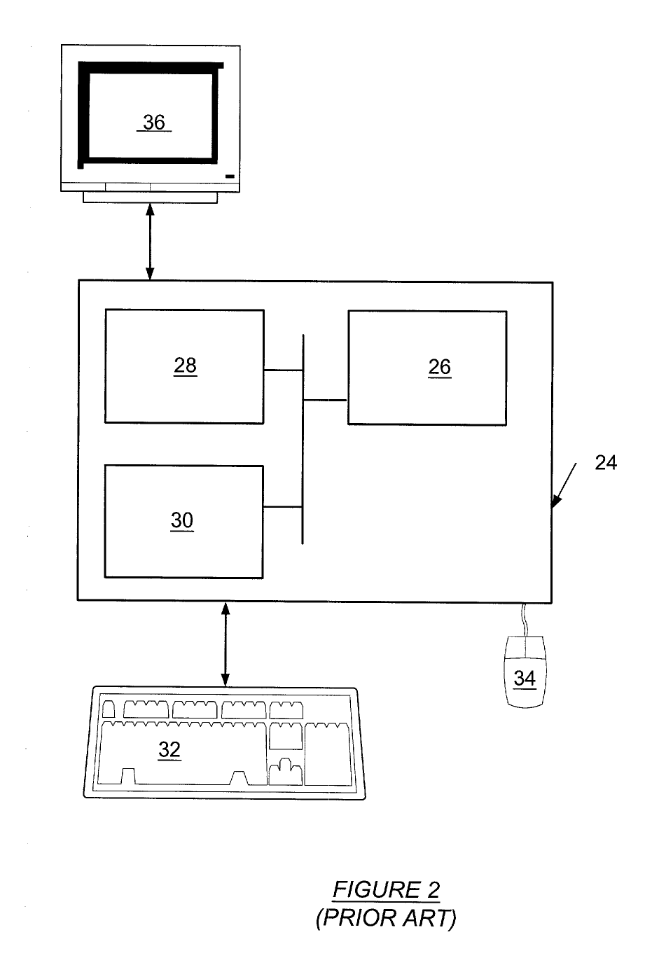

The present invention may be implemented on virtually any type computer regardless of the platform being used. For example, as shown in FIG. 2, a typical computer (24) includes a processor (26), associated memory (28), a storage device (30), and numerous other elements and functionalities typical of today's computers (not shown). The computer (24) may also include input means, such as a keyboard (32) and a mouse (34), and output means, such as a monitor (36). Those skilled in the art will appreciate that these input and output means may take other forms in an accessible environment.

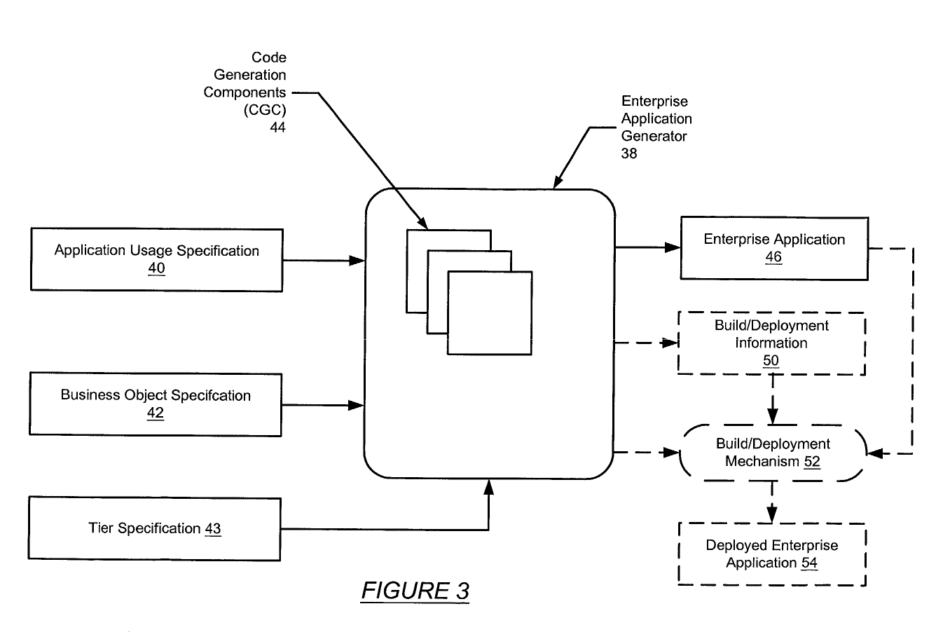

FIG. 3 illustrates a flow diagram for development and generation of an enterprise application in accordance with one or more embodiments of the invention. The enterprise application generation (EAG) (38) takes a business object specification (BOS) (42), an application usage specification (AUS) (40), and a tier specification (43) as inputs and generates an enterprise application (EA) (46).

The BOS (42) defines the characteristics of all business objects to be used in the EA (46). These characteristics may include, but are not limited to, attributes, attribute constraints, persistence information, triggers, relationships, business object methods, etc. For example, the BOS (42) may define a trigger for a particular business object such that when a specific event occurs, such as an update to a data field in a database, a set of Structured Query Language (SQL) statements is “fired-off” to perform an integrity check on the database. Additionally, in accordance with one or more embodiments of the invention, the business object methods define application and process logic. Further, the BOS (42) defines the relationships between the various business objects.

The following code illustrates an exemplary business object specification, in accordance with the embodiment described above.

### Code Sample 1: Business Object Specification

| | |
|---|---|
| 1 | persistent class PurchaseOrder { |

| | |
|---|---|
| 2 | PROPERTIES { UUID = “ID_C0048140360711D6B3B30080C74455C6” }; |
| 3 | persistent Long orderId; |
| 4 | persistent Date orderDate = new Date(0); |
| 5 | persistent String shipToName; |
| 6 | persistent String shipToPhone; |
| 7 | persistent String shipToAddress1; |
| 8 | persistent String shipToAddress2; |
| 9 | persistent String shipToCity; |
| 10 | persistent String shipToState; |
| 11 | persistent String shipToZip; |
| 12 | persistent String shipToCountry = “USA”; |
| 13 | persistent String billToName; |
| 14 | persistent String billToPhone; |
| 15 | persistent String billToAddress1; |
| 16 | persistent String billToAddress2; |
| 17 | persistent String billToCity; |
| 18 | persistent String billToState; |
| 19 | persistent String billToZip; |
| 20 | persistent String billToCountry = “USA”; |
| 21 | computed Decimal orderTotal = |

| | |
|---|---|
| 22 | { |

| | |
|---|---|
| 23 | BigDecimal total = new BigDecimal(0); |
| 24 | Iterator i = getLineItems( ) .iterator( ); |
| 25 | while(i.hasNext( )) { |

| | |
|---|---|
| 26 | LineItem li = (LineItem )i.next( ); |
| 27 | total = total.add(li.getLineTotal( )); |

| 28 | | } |
|---|---|---|
| 29 | | return total; |
| 30 | } | owns (0,n,1,1) LineItem lineltems orderld; |
| 31 | | |

| | |
|---|---|
| 32 | PRIMARY KEY (orderId); |
| 33 | |
| 34 | factory method myOrders (String billToName) returns List of |

| | |
|---|---|
| 35 | PurchaseOrder |
| 36 | |
| 37 | QUERY ( SELECT p |

| | |
|---|---|
| 38 | FROM PurchaseOrder p |
| 39 | WHERE billToName = :billToName |
| 40 | |

| | |
|---|---|
| 41 | factory method nextId( ) returns Long |
| 42 | |

| | |
|---|---|
| 43 | QUERY ( SELECT MAX(p.orderId) + 1 |

| | |
|---|---|
| 44 | FROM PurchaseOrder p |
| 45 | |
| 46 | |

| | |
|---|---|
| 47 | factory method assignNextPK( ) returns PurchaseOrderPK |
| 48 | |

| | |
|---|---|
| 49 | { |

| | |
|---|---|
| 50 | synchronized (this.getClass( )) { |

| | |
|---|---|
| 51 | PurchaseOrderFactory f = (PurchaseOrderFactory |

| | |
|---|---|
| 52 | ) Global.factoryManager ( ) .getFactory(PurchaseOrder .class); |

| | |
|---|---|
| 53 | PurchaseOrderPK pk; |
| 54 | pk = f .newPrimaryKey(nextId( ) .longValue( )); |
| 55 | return pk; |

| | |
|---|---|
| 56 | } |

| | |
|---|---|
| 57 | } |
| 58 | |

| | |
|---|---|
| 59 | } // class PurchaseOrder |
| 60 | |
| 61 | persistent class LineItem { |
| 62 | |

| | |
|---|---|
| 63 | PROPERTIES { UUID = “ID_C00A9BC0360711D6B3B30080C74455C6”[}; |
| 64 | |
| 65 | persistent Long orderLine; |
| 66 | persistent String productId; |
| 67 | persistent String productName; |
| 68 | persistent String productDescription; |
| 69 | persistent Decimal unitPrice; |
| 70 | persistent Long quantity; |
| 71 | computed Decimal lineTotal = ((this.getUnitPrice( ) .multiply( |

| | |
|---|---|
| 72 | new BigDecimal (String.valueOf(this.getQuantity( )))))); |
| 73 | |

| | |
|---|---|
| 74 | PRIMARY KEY (orderId, orderLine); |
| 75 | |
| 76 | |
| 77 | factory method nextLineNumber (Long orderId) returns Long |
| 78 | |

| | |
|---|---|
| 79 | QUERY ( SELECT MAX(li.orderLine) + 1 |

| | |
|---|---|
| 80 | FROM LineItem li |
| 81 | WHERE li.orderId = :orderld |
| 82 | |
| 83 | |

| | |
|---|---|
| 84 | factory method assignNextPK(PurchaseOrder master) returns LineItemPK |
| 85 | |

| | |
|---|---|
| 86 | { |

| | |
|---|---|
| 87 | synchronized (this.getClass( )) { |

| | |
|---|---|
| 88 | LineItemFactory f = (LineItemFactory |

| | |
|---|---|
| 89 | )Global.factoryManager( ) .getFactory(LineItem .class); |

| | |
|---|---|
| 90 | LineItemPK pk = f.newPrimaryKey(master, |

| | |
|---|---|
| 91 | f.nextLineNumber(master.getOrderId( )) .longValue ( )); |

| | |
|---|---|
| 92 | return pk; |

| | |
|---|---|
| 93 | } |

| | |
|---|---|
| 94 | } |
| 95 | |

| | |
|---|---|
| 96 | } // class LineItem |

In the code sample listed above, referred to as “Code Sample 1”, lines 1-58 define a PurchaseOrder business object. Specifically, within the PurchaseOrder business object, lines 3-29 define attributes of the PurchaseOrder business object. Line 30 defines a relationship between the PurchaseOrder business object and a LineItem business object; in particular, the PurchaseOrder business object “owns” the LineItem business object. Line 32 defines the primary key of the PurchaseOrder business object. Lines 34-59 define methods for the PurchaseOrder object.

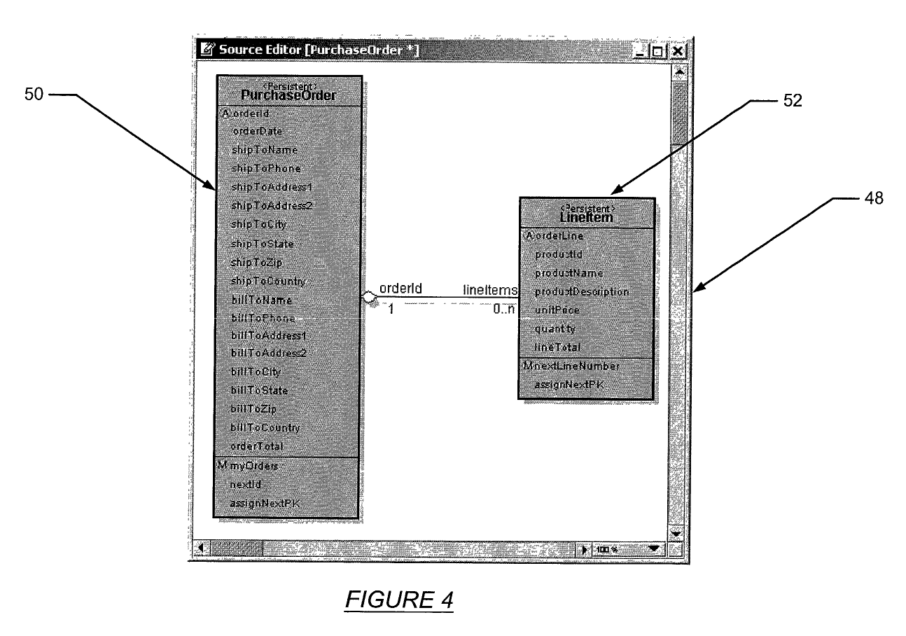

FIG. 4 illustrates a graphical representation of a business object specification in accordance with one or more embodiments of the invention. The graphical representation of the BOS (48) corresponds to “Code sample 1” listed above. The BOS (48) includes two business objects: PurchaseOrder (50), and LineItem (52). Further, the BOS (48) graphically illustrates the “own” relationship. In addition, each business object (PurchaseOrder (50) and LineItem (52)) within the BOS (48) include all attributes and methods defined in “Code Sample 1.”

In one or more embodiments of the invention, an integrated development environment (IDE) is used to graphically define the business object specification. In one or more embodiments of the invention, the IDE is Forte™ for Java™.

Returning to FIG. 3, the AUS (40) defines how the business objects, as defined by the BOS (42), are to be used within the application. In one or more embodiments of the invention, the AUS (40) is defined as a series of states and transitions. A state defines an interaction with a client (i.e., a user, another application, a web service, etc.). The interaction may include, but is not limited to, a user gesture (e.g., a button click, voice commands, etc.), an interaction from another enterprise application (e.g., via a web service using Simple Object Access Protocol (SOAP)), etc. Those skilled in the art will appreciate that an interaction may take on other forms in an accessible environment. For example, in a web-based application, a user may be presented with a screen that requires them to enter a number corresponding to the number of items they wish to purchase and then click the “proceed” button. In this case, that particular web page would represent the state. Further, a state may contain an embedded state. The embedded state corresponds to a state residing in a state. For example, in a web page, a state may correspond to the entire web page and the embedded state may correspond to a frame within the web page. Additionally, a state may also contain a conditional state. For example, a conditional state may display the current date and time to the user, thus, the state is conditional on the current time and data.

The transitions correspond to business logic of the enterprise application. Continuing with the web page example above, when the user clicks the “proceed” button, the transition is initiated. In this particular case, the transition may include code to determine the total price of the products being ordered using the number of items the user previously entered.

The transitions are used to link the various states together forming an overall business process. Further, a particular enterprise application may be defined such that numerous transitions may be used to exit a particular state. For example, in a web-based application, a particular screen may have a “proceed” button and an “exit” button, where each button triggers a different set of business logic. Further, numerous transitions may also be used to enter a particular state. For example, a “proceed” button on one page and a “cancel” button on another page could both result in bringing the user back to an enterprise applications homepage.

Additionally, the AUS (40) may also define interaction variables. The interaction variable defines a piece of data which is going to interact with the user, or to facilitate interactions within the application or with the end user, e.g., parameters passed between states, shared variables, session variables, state variables, etc.

The following code illustrates an exemplary application usage specification, in accordance with the embodiment described above.

### Code Sample 2: Application Usage Specification

| | |
|---|---|
| 1 | package com.sun.purchaseorder; |
| 2 | |
| 3 | bos POApplication = com.sun.purchaseorder; |
| 4 | |
| 5 | session String customerName; |
| 6 | |
| 7 | initial state { |
| 8 | |

| | | |
|---|---|---|
| 9 | { | customerName = “”; |
| 10 | } | |
| 11 | | |

| | | |
|---|---|---|
| 12 | customerName: | C; |
| 13 | | |

| | |
|---|---|
| 14 | transition Start { |

| | |
|---|---|
| 15 | switch (customerName) { |

| | |
|---|---|
| 16 | case “”: return new initial( ); |
| 17 | default: return new ChoosePO( ); |

| | |
|---|---|
| 18 | } |
| 19 | |

| | |
|---|---|
| 20 | } // transition Start |
| 21 | |

| | |
|---|---|
| 22 | } // state initial |
| 23 | |
| 24 | state ChoosePO( ) |
| 25 | { |

| 26 | local List of PurchaseOrder purchaseOrders; | |
|---|---|---|
| 27 | | |
| 28 | { | purchaseOrders = factory(POApplication.PurchaseOrder).myOrders(customerName); |
| 29 | } | |
| 30 | | |

| | | |
|---|---|---|
| 31 | [purchaseOrders(0,n)]: | R { |

| | |
|---|---|
| 32 | orderId “Order ID” |

| | |
|---|---|
| 33 | } |
| 34 | |
| 35 | transition CreatePO “Create Purchase Order” { |

| | |
|---|---|
| 36 | return new CreatePO( ); |
| 37 | |

| | |
|---|---|
| 38 | } // transition CreatePO |
| 39 | |
| 40 | transition DeletePO “Delete Purchase Order” { |

| | |
|---|---|
| 41 | PurchaseOrder po = purchaseOrders.getSelectedOne( ); |
| 42 | factory(POApplication.PurchaseOrder).remove(po); |
| 43 | return new ChoosePO( ); |
| 44 | |

| | |
|---|---|
| 45 | } // transition DeletePO |
| 46 | |
| 47 | transition EditPO “Edit Purchase Order” { |

| | |
|---|---|
| 48 | PurchaseOrder po = purchaseOrders.getSelectedOne( ); |
| 49 | return new EditPO(po); |
| 50 | |

| | |
|---|---|
| 51 | } // transition EditPO |
| 52 | |

| | |
|---|---|
| 53 | } // state ChoosePO |
| 54 | |
| 55 | state CreatePO( ) |
| 56 | { |
| 57 | |
| 58 | |
| 59 | # =“ This state transfers directly to EditPO since it has no usage and one transition ” |

| | |
|---|---|
| 60 | transition CreateAndEditPO { |

| | |
|---|---|
| 61 | PurchaseOrderPK pk = factory(POApplication.PurchaseOrder).assignNextPK( ); |
| 62 | PurchaseOrder po factory(POApplication.PurchaseOrder).create(pk); |
| 63 | po.setBillToName(customerName); |
| 64 | return new EditPO(po); |
| 65 | |

| | |
|---|---|
| 66 | }// transition CreateAndEditPO |
| 67 | |

| | |
|---|---|
| 68 | } // state CreatePO |
| 69 | |
| 70 | state EditPO( PurchaseOrder po) “Edit Purchase Order” |
| 71 | { |
| 72 | |

| | | |
|---|---|---|
| 73 | po: | RW { |

| | | |
|---|---|---|
| 74 | orderId “Order ID”: | R, |

| | |
|---|---|
| 75 | orderDate “Date”, |
| 76 | shipToName “Ship To”, |
| 77 | shipToPhone “Phone”, |
| 78 | shipToAddress1 “Address”, |
| 79 | shipToAddress2 “Address2”, |
| 80 | shipToCity “City”, |
| 81 | shipToState “State”, |
| 82 | shipToZip “Zip Code”, |
| 83 | shipToCountry “Country”, |
| 84 | billToName “Bill To”, |
| 85 | billToPhone “Phone”, |
| 86 | billToAddress1 “Address”, |
| 87 | billToAddress2 “Address2”, |
| 88 | billToCity “City”, |
| 89 | billToState “State”, |
| 90 | billToZip “Zip Code”, |
| 91 | billToCountry “Country”, |
| 92 | [lineItems(0,n)] “Line Items” { |

| | |
|---|---|
| 93 | orderLine “Item”, |
| 94 | productId “Product ID”, |
| 95 | productName “Product”, |
| 96 | productDescription “Description”, |
| 97 | unitPrice “Unit Price”, |
| 98 | quantity “Quantity” |

| | |
|---|---|
| 99 | } |

| | |
|---|---|
| 100 | } |
| 101 | |
| 102 | transition Update { |

| | |
|---|---|
| 103 | return new EditPO(po); |
| 104 | |

| | |
|---|---|
| 105 | } // transition Update |
| 106 | |
| 107 | transition AddLineItem “Add Line Item” { |

| | |
|---|---|
| 108 | LineItemPK pk = factory(POApplication.LineItem).assignNextPK(po); |
| 109 | LineItem li = factory(POApplication.LineItem).create(pk); |
| 110 | return new EditPO(po); |
| 111 | |

| | |
|---|---|
| 112 | } // transition AddLineItem |
| 113 | |
| 114 | transition DeleteLineItem “Delete Line Item” { |

| | |
|---|---|
| 115 | LineItem li = po.lineItems.getSelectedOne( ); |
| 116 | factory(POApplication.LineItem).remove(li); |
| 117 | return new EditPO(po); |
| 118 | |

| | |
|---|---|
| 119 | } // transition DeleteLineItem |
| 120 | |
| 121 | transition Done “Done Editing Purchase Order” { |

| | |
|---|---|
| 122 | return new ChoosePO( ); |
| 123 | |

| | |
|---|---|
| 124 | } // transition Done |
| 125 | |
| 126 | transition Discard “Discard Edits” { |

| | |
|---|---|
| 127 | return new DiscardEdits( ); |
| 128 | |

| | |
|---|---|
| 129 | } // transition Discard |
| 130 | |

| | |
|---|---|
| 131 | } //state EditPO |
| 132 | |
| 133 | state DiscardEdits( ) |
| 134 | { |

| 135 | local String message; | |
|---|---|---|
| 136 | | |
| 137 | { | message = “Edits discarded”; |
| 138 | } | |
| 139 | | |

| | | |
|---|---|---|
| 140 | message: | R; |
| 141 | | |

| | |
|---|---|
| 142 | transition Continue { |

| | |
|---|---|
| 143 | return new ChoosePOO; |
| 144 | |

| | |
|---|---|
| 145 | } // transition Continue |
| 146 | |

| | |
|---|---|
| 147 | }// state DiscardEdits |
| 148 | |

In the code sample listed above referred to as “Code Sample 2”, each state with the corresponding transitions are defined. Lines 7-22 define the Initial State and the necessary information for the Start transition. Similarly, lines 24-53 define the ChoosePO state and corresponding transitions, lines 55-68 define the CreatePO state and corresponding transition, lines 70-131 define the EditPO State and corresponding transitions, and lines 133-147 define the DiscardEdits State and corresponding transitions.

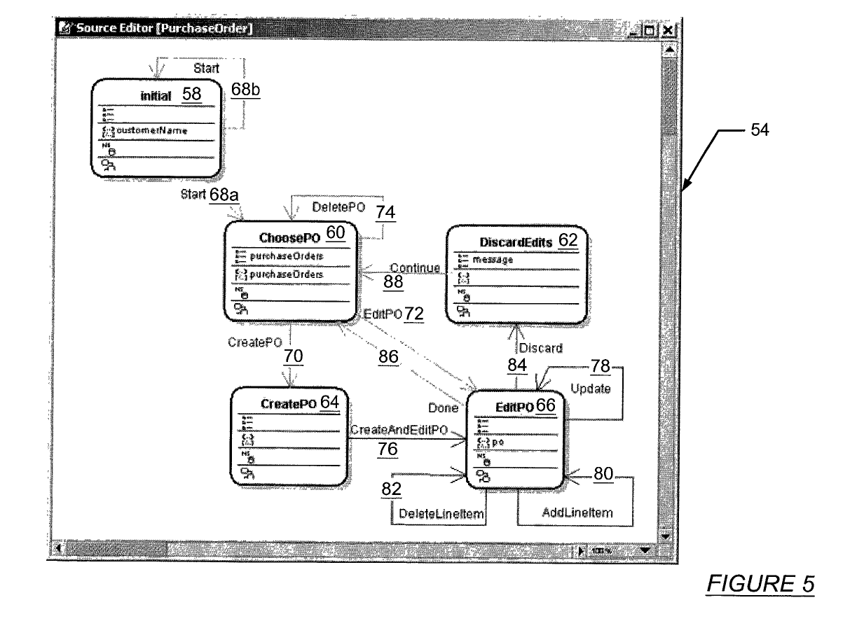

FIG. 5 illustrates a graphical representation of an application usage specification in accordance with one or more embodiments of the invention. The graphical representation of the AUS (54) corresponds to “Code Sample 2” listed above. The AUS (54) uses the BOS (48) described above. The AUS (54) includes five states: Initial (58), ChoosePO (60), DiscardEdits (62), CreatePO (64), and EditPO (66). Linking each state is a series of transitions.

For example, the Initial (58) state includes one transition: Start (68a, 68b). The Start (68a, 68b) transition branches depending on conditions specified in the code (refer to lines 14-17 in Code Sample 2). Thus, the Start (68a, 68b) transition may transition the application to the ChoosePO (60) state via 68a, or return the application to the Initial (58) state via 68b. From the ChoosePO (60) state, the application can transition to the CreatePO (64) state via the CreatePO (70) transition; it can transition to the EditPO (66) state via the EditPO (72) transition; or transition back to itself via the DeletePO (74) transition. From the CreatePO (64) state, the application can transition to the EditPO (66) state via a CreateAndEditPO (76) transition.

The EditPO (66) state includes five transitions. The Update (78) transition, the AddLineItem (80) transition, and the DeleteLineItem (82) transition all return the application back to the EditPO (66) state. The Discard (84) transition places the application in the DiscardEdits (62) state. The Done (86) transition places the application in the ChoosePO (60) state. From the DiscardEdit (62), state the application can transition to the ChoosePO (60) state via the Continue (88) transition.

In one or more embodiments of the invention, an integrated development environment (IDE) is used to graphically define the application usage specification. In one or more embodiments of the invention, the IDE is Forte™ for Java™.

Referring back to FIG. 3, the tier specification (43) defines the tiered architecture upon which the enterprise application (46). For example, the enterprise application (46) may be deployed on a 3-tiered architecture, having a web server, an application server, and a database running a particular DBMS. Alternatively, the enterprise application (46) may be deployed on a 2-tier architecture, having a web server and a database running a DBMS.

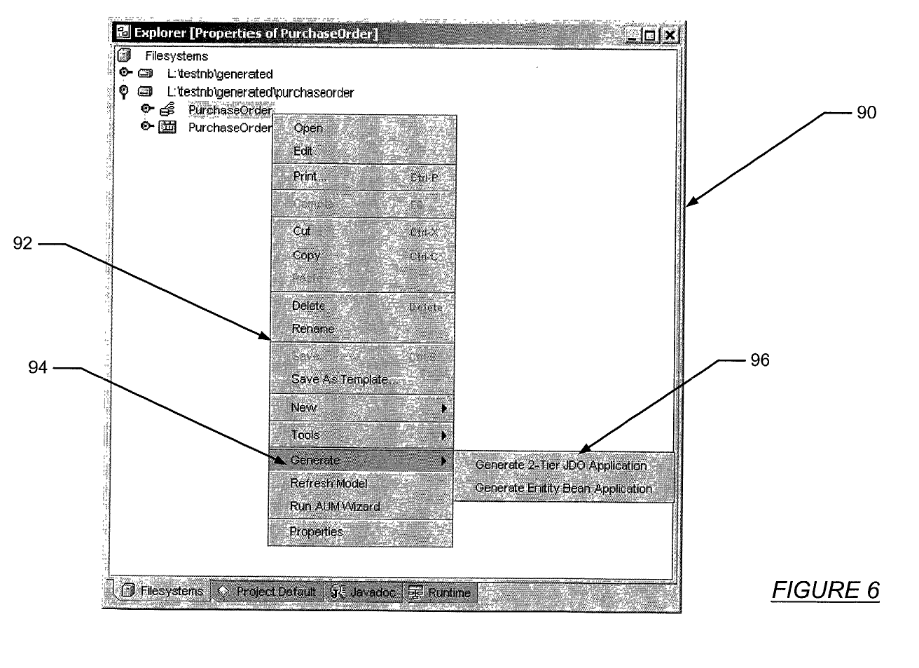

In one or more embodiments, of the invention, the tier specification is input through an IDE. FIG. 6 illustrates an IDE for a tier specification in accordance with one or more embodiments of the invention. The IDE (90) includes a drop-down menu (92) with a “Generate” (94) option. The Generate (94) option further includes a nested drop-down menu (96) with two options: “Generate 2-Tier JDO Application” and “Generate Entity Bean Application.” The “Generate Entity Bean Application” option produces a 3-tier application.

Referring back to FIG. 3, the EAG (38) includes a number of code generation components (CGC) (44). The CGC (44) corresponds to generator components designed specifically for a particular platform. For example, if an enterprise application was to be deployed on an Apache Web Server, an iPlanet™ Application server, and an Oracle® Database Management System, the EAG (38) would contain CGC (44) corresponding to the Apache Web Server, the iPlanet™ Application server, and the Oracle® Database Management System. (iPlanet™ is a trademark of Sun Microsystems, Inc., and Oracle® is a registered trademark of the Oracle Corporation.)

Further, the CGC (44) encapsulates best-mode practices to produce optimized efficient code for the various components in the enterprise application (46). For example, the EAG (38) includes functionality to increase performance efficiency of the generated enterprise application by optimizing application implementation code. This optimization may include, but is not limited to, the use and generation of optimal distribution protocols to ensure maximal network access and response time within a given platform for high application performance and scalability, optimization for lock contention, optimization for memory usage, optimization for processor usage, optimization for code readability, etc.

In the event that a particular component within the enterprise application (46) changes, the enterprise application (46) may be re-generated using the same AUS (40) and BOS (42), provided that the appropriate CGC (44) are present in the EAG (38).

Further, the EAG (38) also includes functionality to determine the most efficient platform for deployment based on the AUS (40) and BOS (42) input into the EAG (38).

Referring again to FIG. 3, in one or more embodiments of the invention, the EAG (38) may also generate build/deployment information (50), and a build/deployment mechanism (52). The build/deployment information (50) encapsulates the information necessary to build and deploy the enterprise application (46) on the specified platform. The build/deployment mechanism (52) typically includes a script or a program that interprets the build/deployment information (50) to automatically deploy the enterprise application (46) onto a platform. The output from the build/deployment mechanism (52) is a deployed enterprise application (54).

One or more embodiments of the invention may include one or more of the following advantages. The invention allows an enterprise application to be created without the knowledge of the tiered architecture. Further, the enterprise application need not be re-designed to be deployed on different architectures rather the same enterprise application specification (i.e., AUS, BOS, Tier specification) may be used to as the enterprise application is migrated from one tier to another.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for generating an enterprise application, comprising:
creating a business object specification defining a characteristic of a business object;
creating an application usage specification defining how the business object is used in the enterprise application;
obtaining a tier specification defining a tiered architecture upon which the enterprise application is executed; and
generating the enterprise application based on the business object specification, the application usage specification, and the tier specification.

2. The method of claim 1, further comprising:
specifying a second tiered architecture upon which the enterprise application is executed to produce a second tier specification; and
re-generating the enterprise application based on the business object specification, the application usage specification, and the second tier specification.

3. The method of claim 1, further comprising:
generating build/deployment information based on the business object specification and the application usage specification;
generating a build/deployment mechanism based on the business object specification and the application usage specification; and
generating a deployed enterprise application based on the enterprise application, the build/deployment information, and the build/deployment mechanism.

4. The method of claim 1, wherein the tier specification is a specification for a plurality of tiers.

5. The method of claim 1, the business object specification comprising a relationship for the business object.

6. The method of claim 1, the business object specification comprising a constraint for the business object.

7. The method of claim 1, the business object specification comprising a trigger for the business object.

8. The method of claim 1, the business object specification comprising a business object method.

9. The method of claim 1, the application usage specification comprising a state and a transition.

10. The method of claim 9, the state comprising an embedded state.

11. The method of claim 9, the state comprising a conditional state.

12. The method of claim 9, wherein the state defines an interaction with a client.

13. The method of claim 1, wherein the application usage specification defines an interaction variable.

14. The method of claim 13, wherein the interaction variable corresponds to the characteristic of the business object in the business object specification.

15. The method of claim 9, the transition comprising business logic of the application.

16. The method of claim 9, further comprising exiting the state using the transition.

17. The method of claim 9, further comprising entering the state using the transition.

18. The method of claim 1, further comprising:
using a graphical user interface to create the business object specification.

19. The method of claim 1, further comprising:
using a graphical user interface to create the application usage specification.

20. The method of claim 1, generating the enterprise application using a code generator.

21. The method of claim 20, the code generator comprising a plurality of code generation components specific to a plurality of platform components.

22. The method of claim 20, wherein the code generator optimizes the application.

23. The method of claim 1, wherein the application usage specification is platform independent.

24. The method of claim 1, wherein the business object specification is platform independent.

25. The method of claim 1, the application usage specification comprising a transaction.

26. A method for generating an enterprise application, comprising:
creating a business object specification defining a characteristic of a business object;
creating an application usage specification defining how the business object is used in the enterprise application;
obtaining a tier specification defining a tiered architecture upon which the enterprise application is executed;
generating the enterprise application based on the business object specification, the application usage specification, and the tier specification;
specifying a second tiered architecture upon which the enterprise application is executed to produce a second tier specification;
re-generating the enterprise application based on the business object specification, the application usage specification, and the second tier specification;
generating build/deployment information based on the business object specification and the application usage specification;
generating a build/deployment mechanism based on the business object specification and the application usage specification; and
generating a deployed enterprise application based on the enterprise application, the build/deployment information, and the build/deployment mechanism.

27. A computer-readable medium having recorded thereon instructions executable by a processor, the instructions for:
receiving a business object specification defining a characteristic of a business object;
receiving an application usage specification defining how the business object is used in the enterprise application;
obtaining a tier specification defining a tiered architecture upon which the enterprise application is executed; and
generating the enterprise application based on the business object specification, the application usage specification, and the tier specification.

28. The computer readable medium of claim 27, further comprising:
specifying a second tiered architecture upon which the enterprise application is executed to produce a second tier specification; and
re-generating the enterprise application based on the business object specification, the application usage specification, and the second tier specification.

29. The computer readable medium of claim 27, further comprising:
generating build/deployment information based on the business object specification and the application usage specification;
generating a build/deployment mechanism based on the business object specification and the application usage specification; and
generating a deployed enterprise application based on the enterprise application, the build/deployment information, and the build/deployment mechanism.

30. The computer readable medium of claim 27, wherein the tier specification is a specification for a plurality of tiers.

31. A computer-readable medium having recorded thereon instructions executable by a processor, the instructions for:
receiving a business object specification defining a characteristic of a business object;
receiving an application usage specification defining how the business object is used in the enterprise application;
obtaining a tier specification defining a tiered architecture upon which the enterprise application is executed;
generating the enterprise application based on the business object specification, the application usage specification, and the tier specification;
specifying a second tiered architecture upon which the enterprise application is executed to produce a second tier specification;
re-generating the enterprise application based on the business object specification, the application usage specification, and the second tier specification;
generating build/deployment information based on the business object specification and the application usage specification;
generating a build/deployment mechanism based on the business object specification and the application usage specification; and
generating a deployed enterprise application based on the enterprise application, the build/deployment information, and the build/deployment mechanism.

32. A computer system to generate an application, comprising:
a processor;
a memory;
an input means;
a display device; and
software instructions stored in the memory for enabling the computer system under control of the processor, to perform:
receiving a business object specification defining a characteristic of a business object;
receiving an application usage specification defining how the business object is used in the enterprise application;
obtaining a tier specification defining a tiered architecture upon which the enterprise application is executed; and
generating the enterprise application based on the business object specification, the application usage specification, and the tier specification.

33. The computer system of claim 32, further comprising:
specifying a second tiered architecture upon which the enterprise application is executed to produce a second tier specification; and
re-generating the enterprise application based on the business object specification, the application usage specification, and the second tier specification.

34. The computer system of claim 32, further comprising:
generating build/deployment information based on the business object specification and the application usage specification;
generating a build/deployment mechanism based on the business object specification and the application usage specification; and
generating a deployed enterprise application based on the enterprise application, the build/deployment information, and the build/deployment mechanism.

35. The computer system of claim 32, wherein the tier specification is a specification for a plurality of tiers.

36. An apparatus for generating an enterprise application, comprising:
means for creating a business object specification defining a characteristic of a business object;
means for creating an application usage specification defining how the business object is used in the enterprise application;
means for obtaining a tier specification defining a tiered architecture upon which the enterprise application is executed; and
means for generating the enterprise application based on the business object specification, the application usage specification, and the tier specification.

37. An apparatus for generating an enterprise application, comprising:
means for creating a business object specification defining a characteristic of a business object;
means for creating an application usage specification defining how the business object is used in the enterprise application;
means for obtaining a tier specification defining a tiered architecture upon which the enterprise application is executed;
means for generating the enterprise application based on the business object specification, the application usage specification, and the tier specification;
means for specifying a second tiered architecture upon which the enterprise application is executed to produce a second tier specification;
means for re-generating the enterprise application based on the business object specification, the application usage specification, and the second tier specification;
means for generating build/deployment information based on the business object specification and the application usage specification;
means for generating a build/deployment mechanism based on the business object specification and the application usage specification; and
means for generating a deployed enterprise application based on the enterprise application, the build/deployment information, and the build/deployment mechanism.
